(19) United States
(12) Patent Application Publication
(10) Pub. No.: US 2020/0036474 A1
(43) Pub. Date: Jan. 30, 2020

(54) RESOURCE MAPPING METHOD AND APPARATUS THEREOF

(71) Applicant: HUAWEI TECHNOLOGIES CO., LTD., Shenzhen (CN)

(72) Inventors: Hejia LUO, Hangzhou (CN); Yourui HUANGFU, Hangzhou (CN); Ying CHEN, Hangzhou (CN); Shengchen DAI, Hangzhou (CN); Rong Li, Hangzhou (CN)

(21) Appl. No.: 16/578,481

(22) Filed: Sep. 23, 2019

Related U.S. Application Data
(63) Continuation of application No. PCT/CN2018/080323, filed on Mar. 23, 2018.

(30) Foreign Application Priority Data
Mar. 24, 2017 (CN) 201710184760.6

(51) Int. Cl. H04L 1/00

(52) U.S. Cl. CPC H04L 1/0033; H04L 1/0013; H04L 1/0038

(57) ABSTRACT

Embodiments of this application disclose a resource mapping method and an apparatus. The method includes: network device performs nested-structure mapping on a modulated symbol set to obtain a first resource block, where the modulated symbol set carries downlink control information corresponding to each of at least one user equipment, and modulated symbols of same user equipment that are carried on the first resource block are consecutive; then reconstructs, the first resource block to obtain a second resource block, where modulated symbols of same user equipment that are carried on the second resource block are non-consecutive; and maps the second resource block to a time-frequency resource, so that the user equipment obtains the modulated symbol set based on the time-frequency resource.

### CROSS-REFERENCE TO RELATED APPLICATIONS

This application is a continuation of International Application No. PCT/CN2018/080323, filed on Mar. 23, 2018, which claims priority to Chinese Patent Application No. 201710184760.6, filed on Mar. 24, 2017. The disclosures of the aforementioned applications are hereby incorporated by reference in their entireties.

### TECHNICAL FIELD

This application relates to the field of communications technologies, and in particular, to a resource mapping method and an apparatus thereof.

### BACKGROUND

Currently, in a wireless communication protocol, a coding scheme of new radio (English: New Radio, NR for short) downlink control information (English: Downlink Control Information, DCI for short) has been determined as a polar (Polar) code. A nested structure (English: nested structure) is proposed in an NR physical downlink control channel (English: Physical Downlink Control Channel, PDCCH for short). The nested structure features that a same resource element (English: Resource Element, RE for short) appears at different aggregation levels (English: Aggregation Level, AL for short). Quantities of candidate locations (English: candidate locations) included at different aggregation levels are different.

Currently, a PDCCH blind detection solution based on the polar code is proposed. For a sending procedure of the solution, refer to FIG. 1. The base station first performs cyclical redundancy check (English: Cyclical Redundancy Check, CRC for short) coding on to-be-sent DCI, to obtain a CRC sequence, and then scrambles a frozen bit (English: frozen bit)/a parity check frozen bit (English: Parity Check frozen, PC frozen for short) in the CRC sequence by using a sequence related to a radio network temporary identifier (English: Radio Network Temporary Identifier, RNTI for short), to obtain the RNTI-scrambled CRC sequence. The sequence related to the RNTI may be a simple copy of the RNTI, or may be a function of the RNTI, for example, a random sequence generated by using the RNTI as a seed. Then, the base station serializes the RNTI-scrambled CRC sequence to the foregoing DCI, to obtain the serialized sequence, and then successively performs channel encoding, rate matching (English: Rate Matching, RM for short), interleaving (English: interleave), modulation, mapping (English: Map), and a sending procedure on the serialized sequence. The channel encoding is polar encoding. Before encoding, the sequence related to the RNTI is used to scramble frozen/PC frozen in a to-be-coded sequence.

For a receiving procedure of this solution, refer to FIG. 2. Two or more candidates at a same aggregation level may be simultaneously decoded. Coded lengths (N) of the two or more simultaneously decoded candidates and a length (K) of a to-be-coded bit (bit) are the same. A quantity of simultaneously decoded candidates cannot exceed an upper limit of a width. Decoding a candidate is actually decoding a log-likelihood ratio (English: Log-Likelihood Ratio, LLR for short) of the candidate.

If time-frequency resource locations of two candidates greatly differ, two LLRs input into a decoder significantly differ, finally causing a loss of decoding performance. Therefore, signal-to-noise ratios (English: Signal-Noise Ratio, SNR for short) of LLRs that are input into the decoder and that are from different candidates are required to be the same. Therefore, before decoding, power balancing needs to be performed on the LLRs. The foregoing solution provides a solution, it is assumed that two candidates are simultaneously decoded, a vector of an LLR of the first candidate is y1, and a vector of an LLR of the second candidate is y2. After balancing, y1p=y1, y2p=y2*sqrt(sum(y1\hat{ }2)/sum(y2\hat{ }2)), and then y1p and y2p are sent to the decoder in the foregoing solution for decoding.

Actually, when a bit width of a fixed point is relatively small, using the foregoing power balancing method generates calculation overheads, and a precision loss is caused during power balancing calculation. Consequently, blind detection at a receive end is affected.

### SUMMARY

A technical problem to be resolved by this application is to provide a resource mapping method and an apparatus thereof, so that a receive end can find, without calculation, a symbol pair with close signal-to-noise ratios at candidate locations at a same aggregation level, which facilitates blind detection at the receive end.

According to a first aspect, this application provides a resource mapping method, including:

performing, by a network device, nested-structure mapping on a modulated symbol set to obtain a first resource block, where the modulated symbol set carries downlink control information corresponding to each of at least one user equipment, and modulated symbols of same user equipment that are carried on the first resource block are consecutive;

reconstructing, by the network device, the first resource block to obtain a second resource block, where modulated symbols of same user equipment that are carried on the second resource block are non-consecutive; and

mapping, by the network device, the second resource block to a time-frequency resource, so that the user equipment obtains the modulated symbol set based on the time-frequency resource.

According to a second aspect, this application provides a resource mapping apparatus, including:

a nested mapping unit, configured to perform nested-structure mapping on a modulated symbol set to obtain a first resource block, where the modulated symbol set carries downlink control information corresponding to each of at least one user equipment, and modulated symbols of same user equipment that are carried on the first resource block are consecutive;

a resource block reconstruction unit, configured to reconstruct the first resource block to obtain a second resource block, where modulated symbols of same user equipment that are carried on the second resource block are non-consecutive; and

a time-frequency mapping unit, configured to map the second resource block to a time-frequency resource, so that the user equipment obtains the modulated symbol set based on the time-frequency resource.

According to a third aspect, this application provides a network device, including:

a memory, configured to store a program; and

a processor, configured to execute the program stored in the memory, where when the program is executed, the processor performs nested-structure mapping on a modulated symbol set to obtain a first resource block, where the modulated symbol set carries downlink control information corresponding to each of at least one user equipment, and modulated symbols of same user equipment that are carried on the first resource block are consecutive; the processor reconstructs the first resource block to obtain a second resource block, where modulated symbols of same user equipment that are carried on the second resource block are non-consecutive; and the processor maps the second resource block to a time-frequency resource, so that the user equipment obtains the modulated symbol set based on the time-frequency resource.

According to a fourth aspect, this application provides a computer-readable storage medium, including an instruction. When run on a computer, the instruction enables the computer to perform the decoding method according to the first aspect.

With reference to all the aspects above, in a possible design, the network device performs one time of row-column interleaving processing on the first resource block to obtain the second resource block, where a column width of the one time of row-column interleaving is 2n, and n is a positive integer. Performing the one time of row-column interleaving disrupts a sequence of carrying same modulated symbols on the first resource block.

With reference to all the aspects above, in a possible design, the network device performs at least two times of row-column interleaving processing on the first resource block to obtain the second resource block, where a column width of each of the at least two times of row-column interleaving is 2n, n is a positive integer, and column widths of any two adjacent times of row-column interleaving are the same or different. Performing a plurality of times of row-column interleaving is beneficial to achieving a time-frequency diversity effect.

With reference to all the aspects above, in a possible design, before performing the nested-structure mapping on the modulated symbol set to obtain the first resource block, the network device successively performs channel encoding, rate matching, interleaving, and modulation on the downlink control information and cyclic redundancy code check information that correspond to each user equipment, to obtain the modulated symbol set, where the modulated symbol set includes modulated symbols corresponding to the user equipment.

According to a fifth aspect, this application provides a resource demapping method, including:

receiving, by user equipment, time-frequency resource indication information, and obtaining a time-frequency resource according to the time-frequency resource indication information;

performing, by the user equipment, time-frequency resource demapping on the time-frequency resource to obtain a nested-structure resource block; and

performing, by the user equipment, nested-structure demapping on the nested-structure resource block to obtain a modulated symbol set, where the modulated symbol set carries downlink control information corresponding to each of at least one user equipment.

According to a sixth aspect, this application provides a resource demapping apparatus, including:

a receiving unit, configured to receive time-frequency resource indication information;

an extraction unit, configured to extract a time-frequency resource according to the time-frequency resource indication information; and

a demapping unit, configured to perform time-frequency resource demapping on the time-frequency resource to obtain a nested-structure resource block, where

the demapping unit is further configured to perform nested-structure demapping on the nested-structure resource block to obtain a modulated symbol set, where the modulated symbol set carries downlink control information corresponding to each of at least one user equipment.

According to a seventh aspect, this application provides user equipment, including:

a memory, configured to store a program;

a transceiver, configured to receive time-frequency resource indication information; and

a processor, configured to execute the program stored in the memory, where when the program is executed, the processor obtains a time-frequency resource according to the time-frequency resource indication information; the processor performs time-frequency resource demapping on the time-frequency resource to obtain a nested-structure resource block; and the processor performs nested-structure demapping on the nested-structure resource block to obtain a modulated symbol set, where the modulated symbol set carries downlink control information corresponding to each of at least one user equipment.

According to an eighth aspect, this application provides a computer-readable storage medium, including an instruction, where when run on a computer, the instruction enables the computer to perform the decoding method according to the fifth aspect.

With reference to all the aspects above, in a possible design, after performing the nested-structure demapping on the nested-structure resource block to obtain the modulated symbol set, the user equipment successively performs demodulation, deinterleaving, rate dematching, and blind detection on the modulated symbol set; and the user equipment obtains, if the blind detection succeeds, the downlink control information corresponding to the user equipment.

According to this application, the first resource block obtained through the nested-structure mapping is reconstructed, so that the modulated symbols of the same user equipment that are mapped to the time-frequency resource are non-consecutive, and further the user equipment can find, without calculation, a symbol pair with close signal-to-noise ratios at candidate locations at a same aggregation level, which facilitates the blind detection by the user equipment.

### BRIEF DESCRIPTION OF DRAWINGS

To more clearly describe the technical solutions in this application or the Background, the following describes the accompanying drawings required in this application or the Background.

FIG. 1 is a schematic diagram of a sending procedure of a PDCCH blind detection solution based on a polar code;

FIG. 2 is a schematic diagram of a receiving procedure of a PDCCH blind detection solution based on a polar code;

FIG. 3 is a basic flowchart of wireless communication;

FIG. 4 is an application scenario diagram according to this application;

FIG. 5 is a construction diagram of an Arikan polar code;

FIG. 6 is a construction diagram of a CA polar code;

FIG. 7 is a construction diagram of a PC polar code;

FIG. 8 is a schematic diagram of typical nested-structure resource distribution;

FIG. 9 is an example diagram of resource mapping of a transmit end;

FIG. 10 is an example diagram of candidate distribution for blind detection at a receive end;

FIG. 11 is a flowchart of nested-structure-based communication;

FIG. 12 is a schematic flowchart of a resource mapping method according to this application;

FIG. 13a is an example diagram of resource mapping of a network device according to this application;

FIG. 13b is another example diagram of resource mapping of a network device according to this application;

FIG. 14 is a schematic flowchart of a resource demapping method according to this application;

FIG. 15a is an example diagram of candidate distribution obtained through demapping according to this application;

FIG. 15b is another example diagram of candidate distribution obtained through demapping according to this application;

FIG. 16 is a schematic structural diagram of a resource mapping apparatus according to this application;

FIG. 17 is a schematic structural diagram of a network device according to this application;

FIG. 18 is a schematic structural diagram of a resource demapping apparatus according to this application; and

FIG. 19 is a schematic structural diagram of user equipment according to this application.

### DESCRIPTION OF EMBODIMENTS

The following further describes specific embodiments of this application in detail with reference to accompanying drawings.

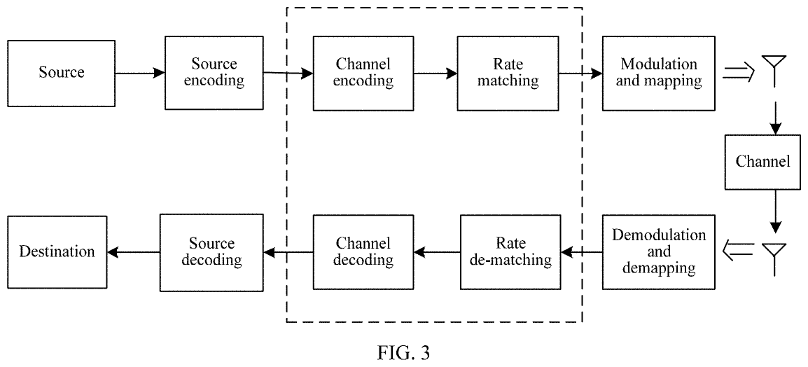

FIG. 3 shows a basic procedure of wireless communication. At a transmit end, a source successively performs source encoding, channel encoding, rate matching, and modulation and mapping for sending. At a receive end, a destination successively performs demapping and demodulation, rate de-matching, channel decoding, and source decoding for receiving. A polar code may be used for the channel encoding and decoding. A code length of an original polar code (a mother code) is an integer power of 2. Therefore, during actual application, a polar code of any code length needs to be implemented through rate matching. At the transmit end, the rate matching is performed after the channel encoding, to implement any target code length. At the receive end, the rate de-matching is performed before the channel decoding. It should be noted that in addition to the basic procedure, the wireless communication further includes additional procedures (for example, precoding and interleaving). In view of that the additional procedures are common general knowledge for a person skilled in the art, examples are not listed one by one. A CRC sequence and CRC information that are mentioned in this application are different names of a same object.

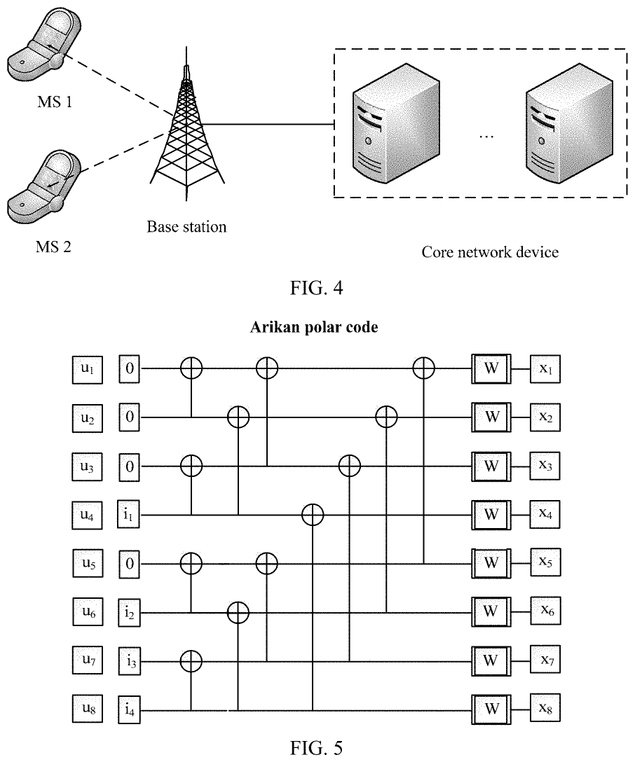

This application may be applied to a wireless communications system. The wireless communications system usually includes cells. Each cell includes a base station (English: Base Station, BS for short), and the base station provides a communication service for a plurality of mobile stations (English: Mobile Station, MS for short). As shown in FIG. 4, the base station is connected to core network devices. The base station includes a baseband unit (English: Baseband Unit, BBU for short) and a remote radio unit (English: Remote Radio Unit, RRU for short). The BBU and the RRU may be placed at different places. For example, the RRU is remotely deployed and is placed in an open area having a high traffic volume, and the BBU is placed in a central equipment room. Alternatively, the BBU and the RRU may be placed in a same equipment room. Alternatively, the BBU and the RRU may be different components on a same rack.

It should be noted that the wireless communications system mentioned in this application includes but is not limited to a narrowband Internet of things (English: Narrow Band-Internet of Things, NB-IoT for short) system, a global system for mobile communications (English: Global System for Mobile Communications, GSM for short) system, an enhanced data rates for GSM evolution (English: Enhanced Data rates for GSM Evolution, EDGE for short) system, a wideband code division multiple access (English: Wideband Code Division Multiple Access, WCDMA for short) system, a code division multiple access 2000 (English: Code Division Multiple Access 2000, CDMA 2000 for short) system, a time division-synchronous code division multiple access (English: Time Division-Synchronization Code Division Multiple Access, TD-SCDMA for short) system, a long term evolution (English: Long Term Evolution, LTE for short) system, and three major application scenarios, namely, enhanced mobile broadband (English: enhanced Mobile Broadband, eMBB for short), ultra-reliable and low latency communications (English: Ultra Reliable Low Latency Communications, URLLC for short), and massive machine type communications (English: massive Machine Type Communications, mMTC for short), of a next-generation 5G mobile communications system.

In this application, the base station is an apparatus deployed in a radio access network and configured to provide a wireless communication function for the MS. The base station may include various forms of macro base stations, micro base stations (also referred to as small cells), relay stations, access points, and the like. A device having a function of a base station may have different names in systems that use different radio access technologies. For example, in the long term evolution (English: Long Term Evolution, LTE for short) system, the device is referred to as an evolved NodeB (English: evolved NodeB, eNB or eNodeB); and in a 3rd generation (English: 3rd Generation, 3G for short) system, the device is referred to as a NodeB (English: NodeB). For ease of description, in all the embodiments of this application, the foregoing apparatuses that provide the wireless communication function for the MS are collectively referred to as a network device.

The MS in this application may include various handheld devices, in-vehicle devices, wearable devices, or computing devices that have the wireless communication function, or other processing devices connected to a wireless modem. The MS may also be referred to as a terminal (English: Terminal). The MS may alternatively include a subscriber unit (English: subscriber unit), a cellular phone (English: cellular phone), a smartphone (English: smartphone), a wireless data card, a personal digital assistant (English: Personal Digital Assistant, PDA for short) computer, a tablet computer, a wireless modem (English: modem), a handset (English: handset), a laptop computer (English: laptop computer), a machine type communication (English: Machine Type Communication, MTC for short) terminal, or the like. For ease of description, in all the embodiments of this application, the devices mentioned above are collectively referred to as user equipment.

The following briefly describes the polar code.

In a communications system, channel encoding is usually performed to improve reliability of data transmission, to ensure quality of communication. The polar code proposed by the Turkish processor Arikan is a code that is first theoretically proved to be capable of achieving a Shannon capacity and that has low encoding and decoding complexity. The polar code is also a linear block code. An encoding matrix of the polar code is G_{N}. An encoding process is x₁^{N}=u₁^{N}G_{N}. u₁^{N}=(u₁, u₂, . . . u_{N}) is a binary row vector, and has a length of N (namely, a code length). G_{N} is an N×N matrix, and G_{N}=F₂^{⊕(log}^{₂}^{(N))}. F₂^{⊕(log}^{₂}^{^{(N)}}⁾ is defined as a Kronecker (Kronecker) product of log₂^{N} matrices F₂. The foregoing matrix

$${F}_{2} = [ \begin{matrix}1 & 0 \\ 1 & 1\end{matrix} ] .$$

In the encoding process of the polar code, some bits in u₁^{N} are used to carry information, and are referred to as an information bit set. A set of indexes of the bits is denoted by A. The other bits are set to fixed values pre-agreed by the transmit end and the receive end, and are referred to as a fixed bit set or a frozen bit set (frozen bits). A set of indexes of the bits is represented by a complementary set A^{C} of A. The encoding process of the polar code is equivalent to: x₁^{N}=u_{A} G_{N}(A)⊕u_{A}_{^{c}}G_{N}(A^{c}). Herein, GN(A) is a submatrix obtained by rows corresponding to the indexes in the set A in GN, and GN(AC) is a submatrix obtained by rows corresponding to the indexes in the set A^{C} in GN. u_{A} is the information bit set in u₁^{N}, and a quantity of information bits is K. u_{A}_{^{c}} is the fixed bit set in u₁^{N}, a quantity of fixed bits is (N−K), and the fixed bits are known bits. The fixed bits are usually set to 0. However, the fixed bits may be randomly set, provided that the fixed bits are pre-agreed by the transmit end and the receive end. In this way, an encoded output of the polar code may be simplified as: x₁^{N}=u_{A}G_{N}(A). Herein, u_{A} is the information bit set in u₁^{N}, and u_{A} is a row vector having a length of K. In other words, |A|=K. |⋅| represents a quantity of elements in a set, K is a size of an information block, G_{N}(A) is the submatrix obtained by the rows corresponding to the indexes in the set A in the matrix G_{N}, and G_{N} (A) is a K×N matrix.

A construction process of the polar code is a selection process of the set A, and determines performance of the polar code. The construction process of the polar code is usually: determining, based on a code length N of a mother code, that there are N polarized channels in total that respectively correspond to N rows of the encoding matrix, calculating reliability of the polarized channels, using indexes of the first K polarized channels having higher reliability as elements in the set A, and using indexes corresponding to the remaining (N−K) polarized channels as elements in the set A^{C} of the indexes of the fixed bits. The set A determines locations of the information bits, and the set A^{C} determines locations of the fixed bits.

It may be learned from the encoding matrix that the code length of an original polar code (the mother code) is an integer power of 2. During actual application, a polar code of any code length needs to be implemented through rate matching.

To improve the performance of the polar code, check precoding is usually first performed on the information bit set, and then polar encoding is performed. There are two common check precoding schemes: CRC concatenated polar encoding and PC concatenated polar encoding. Currently, the polar encoding includes: conventional Arikan polar encoding, CA polar encoding, and PC polar encoding.

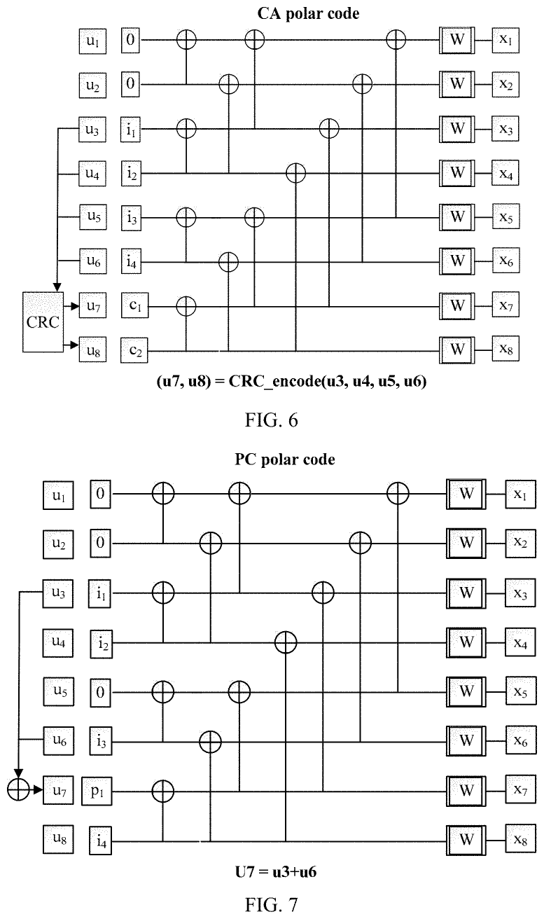

Conventional Arikan polar encoding in FIG. 5 is described. {u1, u2, u3, u5} is set as a fixed bit set, {u4, u6, u7, u8} is set as an information bit set, and four information bits in an information vector having a length of 4 are encoded into eight encoded bits.

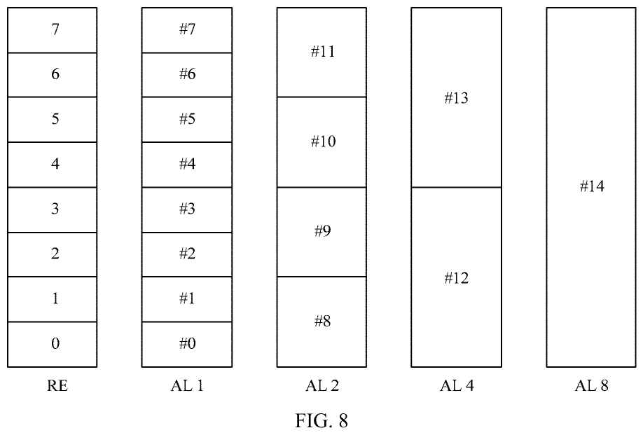

CA polar encoding in FIG. 6 is described. {u1, u2} is set as a fixed bit set, {u3, u4, u5, u6} is set as an information bit set, and {u7, u8} is a CRC bit set. Values of {u7, u8} are obtained by performing CRC on {u3, u4, u5, u6}.

For the CA polar encoding, a CRC-aided successive cancellation list (CRC-Aided Successive Cancellation List, CA-SCL) decoding algorithm is used. In the CA-SCL decoding algorithm, a path on which CRC succeeds is selected, as a decoded output through CRC check, from candidate paths of an SCL decoded output.

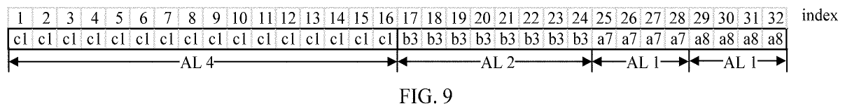

PC polar encoding in FIG. 7 is described. {u1, u2, u5} is set as a fixed bit set, {u3, u4, u6, u8} is set as an information bit set, and {u7} is a PC fixed bit set. A value of {u7} is obtained by performing exclusive-OR on {u3, u6}.

For the PC Polar encoding, a decoding algorithm is based on the SCL decoding algorithm. A process of sorting and pruning is completed in the decoding process by using the PC fixed bit set, and a most reliable path is finally output.

The following briefly describes a nested structure.

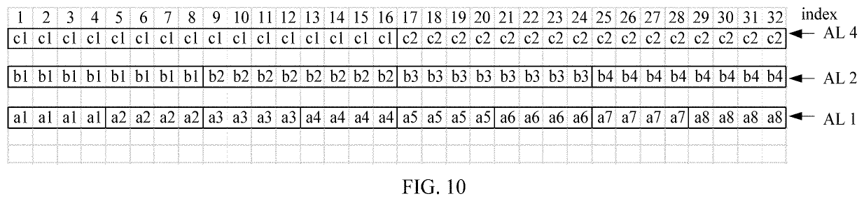

FIG. 8 is a schematic diagram of typical nested-structure resource distribution. That a nested structure includes eight REs and a highest aggregation level supported by the nested structure is an AL 8 is used as an example. FIG. 8 shows eight REs on a leftmost side and candidates included at aggregation levels. For user equipment (English: User Equipment, UE for short), blind detection is performed in four configurations an AL 1 to the AL 8. Eight candidates #0 to #7 are included at the AL 1. Four candidates #8 to #11 are included at the AL 2. Two candidates #12 and #13 are included at the AL 4. Only one candidate #14 is included at the AL 8. The UE needs to perform a maximum of 15 blind detections in total. One time of decoding and one CRC check are needed for each blind detection. If the CRC check succeeds, it indicates that the blind detection succeeds, so that the UE obtains required data. Assuming that one nested structure includes N REs, a quantity of candidates at each AL and a quantity of REs occupied by each candidate are shown in the table below. Quantities of coded bits (English: bit) carried in different candidates at a same AL are the same.

| | Quantity of candidates | Quantity of occupied REs |
|---|---|---|
| AL 1 | 8 | N/8 |
| AL 2 | 4 | N/4 |
| AL 4 | 2 | N/2 |
| AL 8 | 1 | N/1 |

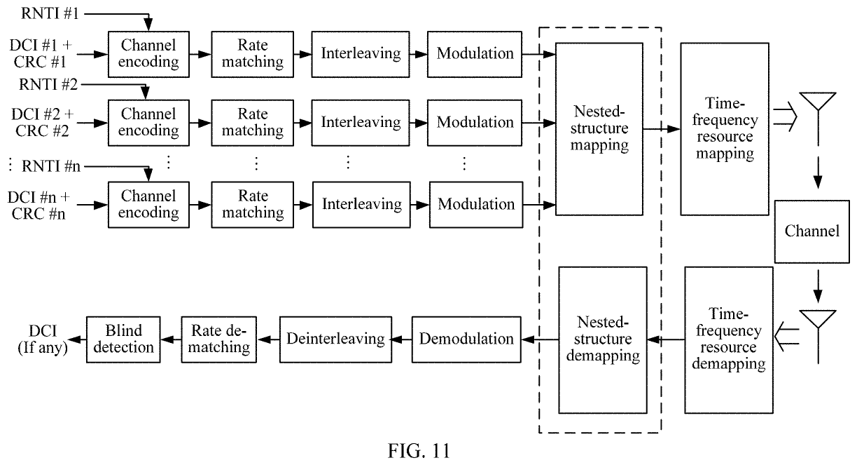

FIG. 9 is an example diagram of resource mapping of a transmit end. That a smallest nested structure (including 32 REs) is filled with one PDCCH at an AL 4, one PDCCH at an AL 2, and two PDCCHs at an AL 1 is used as an example. Indexes of the 32 REs are 1 to 32, and during actual application, may alternatively be 0 to 31. The AL 4 occupies REs whose indexes are 1 to 16. Symbols mapped to the REs are c1. To be specific, a symbol of UE that is carried at a candidate at the AL 4 is c1. The AL 2 occupies REs whose indexes are 17 to 24. Symbols mapped to the REs are b3. To be specific, a symbol of UE that is carried at a candidate at the AL 2 is b3. One AL 1 occupies REs whose indexes are 25 to 28. Symbols mapped to the REs are a7. To be specific, a symbol of UE that is carried at a candidate at the AL 1 is a7. The other AL 1 occupies REs whose indexes are 29 to 32. Symbols mapped to the REs are a8. To be specific, a symbol of UE that is carried at a candidate at the AL 1 is a8.

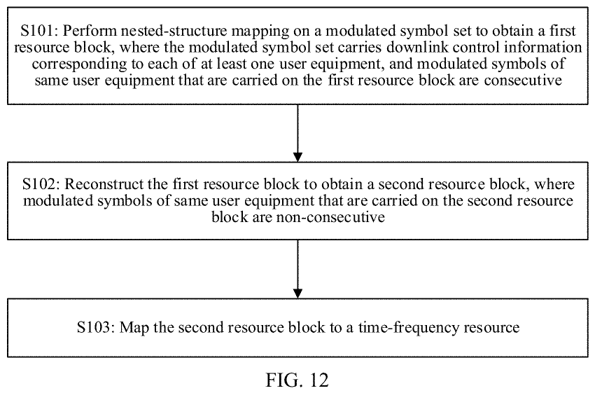

FIG. 10 is an example diagram of candidate distribution for blind detection at a receive end. Demapping is performed at an AL 4 to obtain symbols c1 and c2. Demapping is performed at an AL 2 to obtain symbols b1, b2, b3, and b4. Demapping is performed at an AL 1 to obtain symbols a1, a2, a3, a4, a5, a6, a7, and a8.

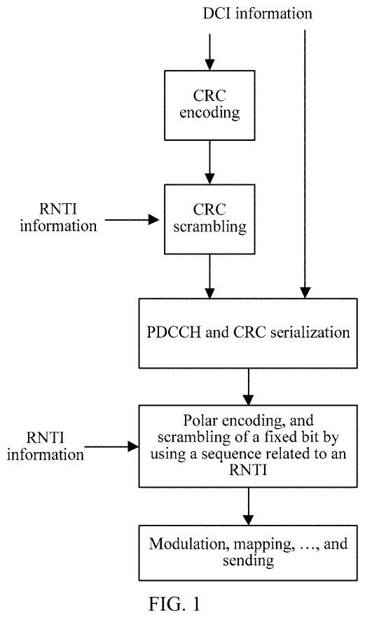

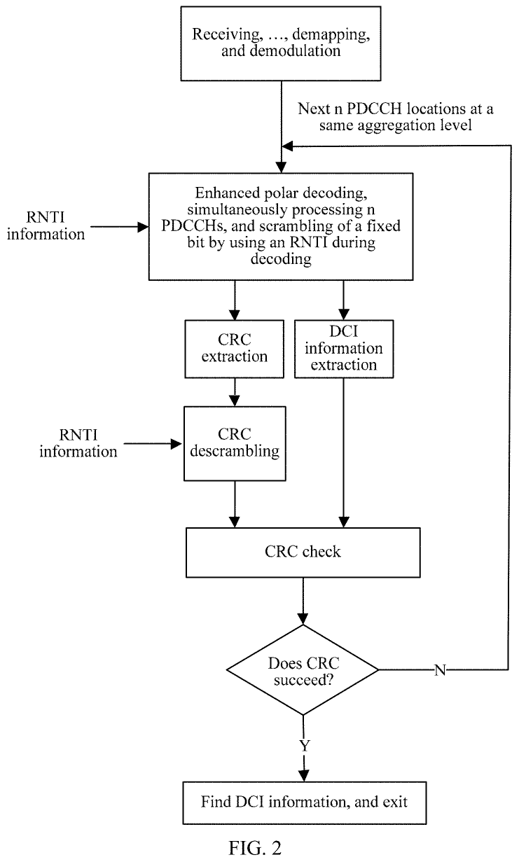

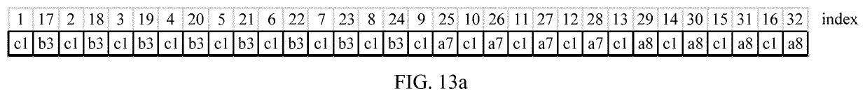

FIG. 11 is a flowchart of nested-structure-based communication. Mapping procedures and demapping procedures in FIG. 3 are elaborated. Two mapping procedures are nested-structure mapping and time-frequency resource mapping. Correspondingly, two demapping procedures are nested-structure demapping and time-frequency resource demapping. The nested-structure mapping is mapping a modulated symbol to a nested-structure resource block. The time-frequency resource mapping is mapping the nested-structure resource block after the nested-structure mapping to a time-frequency resource. FIG. 9 may show a result obtained through two times of mapping. A polar code may be used for channel encoding in FIG. 11. In this case, a procedure at a transmit end is consistent with that in FIG. 1, a procedure at a receive end may be consistent with that in FIG. 2, and two or more candidates at a same aggregation level may be simultaneously decoded during blind detection.

It should be noted that FIG. 9 may be based on FIG. 1, FIG. 10 may be based on FIG. 2, and FIG. 9 and FIG. 10 are merely used for description through an example. Actually, REs in a resource block are not necessarily completely adjacent. Consequently, SNRs of a1 and a2 may be different, or SNRs of b1 and b2 may be different, or SNRs of c1 and c2 may be different, where a1 and a2, b1 and b2, and c1 and c2 are obtained through demapping at the receive end. In other words, SNRs of symbols carried at adjacent candidates at a same aggregation level may be caused to be different.

In view of this, this application provides a resource mapping method and an apparatus thereof, so that a receive end can find, without calculation, a symbol pair with close signal-to-noise ratios at candidate locations at a same aggregation level, which facilitates blind detection at the receive end.

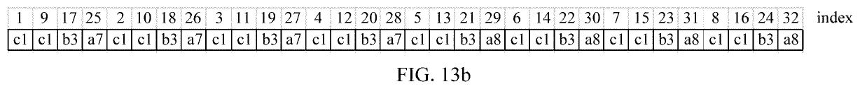

FIG. 12 is a schematic flowchart of a resource mapping method according to this application. The method includes but is not limited to the following steps.

Step S101: A network device performs nested-structure mapping on a modulated symbol set to obtain a first resource block, where the modulated symbol set carries downlink control information corresponding to each of at least one user equipment, and modulated symbols of same user equipment that are carried on the first resource block are consecutive.

The modulated symbol set carries the downlink control information corresponding to each of the at least one user equipment. Symbols in the modulated symbol set that are mapped to the first several slots of a time-frequency resource are used for PDCCH transmission. The modulated symbol set includes a modulated symbol corresponding to each user equipment, namely, a symbol output from a modulation module in FIG. 11 and input into a nested-structure mapping module. Modulation may be quadrature amplitude modulation (Quadrature Amplitude Modulation, QAM) in FIG. 1, or may be modulation in another manner. Referring to FIG. 11, the network device successively performs channel encoding, rate matching, interleaving, and modulation on the DCI information and CRC information of each user equipment, to obtain the modulated symbol corresponding to the user equipment, and further obtain the modulated symbol set. For the channel encoding and a process before the channel encoding, refer to the sending procedure shown in FIG. 1.

The network device performs the nested-structure mapping on the modulated symbol set to obtain the first resource block, and the modulated symbols of the same user equipment that are carried on the first resource block are consecutive. For an effect of mapping the first resource block to the time-frequency resource, refer to FIG. 9. A modulated symbol c1 of user equipment is carried at a candidate at the AL 4. A modulated symbol b3 of user equipment is carried at a candidate at the AL 2. A modulated symbol a7 of user equipment is carried at a candidate at one AL 1. A modulated symbol a8 of user equipment is carried at a candidate at the other AL 1. It may be understood that candidates at which same modulated symbols are carried on the first resource block are consecutive. The same modulated symbols are modulated symbols of same user equipment.

Step S102: The network device reconstructs the first resource block to obtain a second resource block, where modulated symbols of same user equipment that are carried on the second resource block are non-consecutive.

If the first resource block is directly mapped to the time-frequency resource, the SNRs of the symbols that are carried at the adjacent candidates at the same aggregation level and that are obtained through the demapping at the receive end may be caused to be different. For example, in FIG. 10, the SNRs of a1 and a2 may be different, or the SNRs of b1 and b2 may be different, or the SNRs of c1 and c2 may be different. Therefore, in this application, a reconstruction process is added between two sections, namely, the nested-structure mapping and the time-frequency resource mapping, in the schematic flowchart of communication shown in FIG. 11. It may also be understood that the reconstruction process is elaboration of the nested-structure mapping section.

Specifically, the network device reconstructs the first resource block to obtain the second resource block, where the modulated symbols of the same user equipment that are carried on the second resource block are non-consecutive. It may be understood that candidates at which same modulated symbols are carried on the second resource block are non-consecutive.

Solution 1: The network device performs one time of row-column interleaving processing on the first resource block to obtain the second resource block, where a column width of the one time of row-column interleaving is 2n, and n is a positive integer.

Solution 2: The network device performs at least two times of row-column interleaving processing on the first resource block to obtain the second resource block, where a column width of each of the at least two times of row-column interleaving is 2n, n is a positive integer, and column widths of any two adjacent times of row-column interleaving may be the same or may be different. For example, the column width of each time of row-column interleaving is 2; or a column width of the first time of row-column interleaving is 2, and a column width of the second time of row-column interleaving is 4; or a column width of the first time of row-column interleaving is 2, a column width of the second time of row-column interleaving is 4, and a column width of the third time of row-column interleaving is 2; or a column width of the first time of row-column interleaving is 2, a column width of the second time of row-column interleaving is 4, and a column width of the third time of row-column interleaving is 4. A quantity of the at least two times of row-column interleaving is not limited herein.

It may be understood that the reconstruction is to change a sequence of candidate locations at which same modulated symbols are carried. In this application, reconstruction may alternatively be performed according to another method.

Step S103: The network device maps the second resource block to a time-frequency resource.

Specifically, the network device maps the second resource block to the time-frequency resource, so that all user equipments within coverage of the network device obtains the modulated symbol set based on the time-frequency resource.

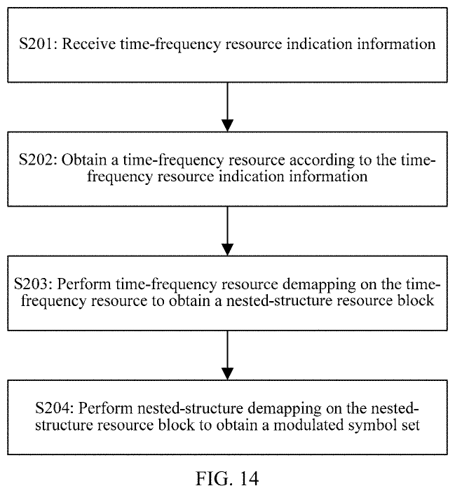

For the solution 1, a column width of the row-column interleaving being 2 is used as an example. For an example diagram of resource mapping of the network device, refer to FIG. 13a. Indexes of REs in FIG. 13a follow the indexes of the REs in FIG. 9. It may be learned that, in FIG. 13a, c1 and b3 are adjacent, c1 and a7 are adjacent, c1 and a8 are adjacent, all c1s are non-consecutive, all b3s are non-consecutive, all a7s are non-consecutive, and all a8s are non-consecutive. In other words, carried modulated symbols of same user equipment are non-consecutive.

For the solution 2, two times of row-column interleaving and a column width of each time of row-column interleaving being 2 are used as an example. For an example diagram of resource mapping of the network device, refer to FIG. 13b. Indexes of REs in FIG. 13b follow the indexes of the REs in FIG. 9. It may be learned that, in FIG. 13b, c1 and b3 are adjacent, b3 and a7 are adjacent, a7 and c1 are adjacent, c1 and a8 are adjacent, . . . , all c1s are non-consecutive, all b3s are non-consecutive, all a7s are non-consecutive, and all a8s are non-consecutive. In other words, carried modulated symbols of same user equipment are non-consecutive.

It should be noted that, the example diagram shown in FIG. 13b can also be obtained if the network device performs one time of row-column interleaving processing having a column width of 4.

Compared with the solution 1, in the solution 2, for a candidate at a lower aggregation level, REs at the candidate can be distributed farther, to achieve a time-frequency diversity effect.

Optionally, after the second resource block is mapped to the time-frequency resource, the network device sends time-frequency resource indication information to a plurality of user equipments within the coverage of the network device, and indicates a time-frequency resource occupied by a mapped modulated symbol set, to instruct these user equipments to extract the time-frequency resource according to the time-frequency resource indication information, and further make it convenient for these user equipments to obtain the modulated symbol set based on the time-frequency resource. The time-frequency resource indication information may be delivered through wireless signaling.

Optionally, the network device informs, through some signaling, all user equipments in a cell of a quantity of times of row-column interleaving and a column width of each time of row-column interleaving.

In the embodiment shown in FIG. 12, the first resource block obtained through the nested-structure mapping is reconstructed, so that the modulated symbols of the same user equipment that are mapped to the time-frequency resource are non-consecutive, and the receive end can find, without calculation, a symbol pair with close signal-to-noise ratios at candidate locations at a same aggregation level, which facilitates blind detection at the receive end.

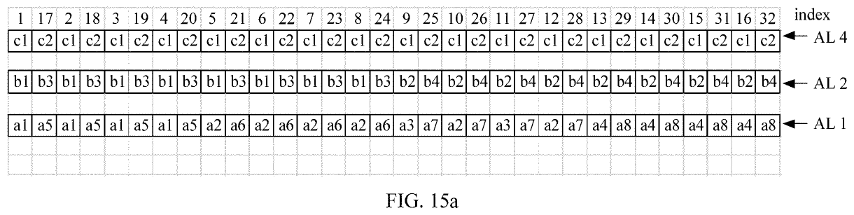

FIG. 14 is a schematic flowchart of a resource demapping method according to this application. The method includes but is not limited to the following steps.

Step S201: User equipment receives time-frequency resource indication information.

Specifically, the user equipment is any one of all user equipments in a cell served by a network device. The user equipment may receive the time-frequency resource indication information through wireless signaling. The time-frequency resource indication information indicates a time-frequency resource occupied by a modulated symbol set mapped by the network device. The modulated symbol set carries downlink control information corresponding to each of at least one user equipment.

Step S202: The user equipment obtains the time-frequency resource according to the time-frequency resource indication information.

Specifically, the user equipment obtains, according to the time-frequency resource indication information, the time-frequency resource occupied by the modulated symbol set mapped by the network device.

Step S203: The user equipment performs time-frequency resource demapping on the time-frequency resource to obtain a nested-structure resource block.

Step S204: The user equipment performs nested-structure demapping on the nested-structure resource block to obtain a modulated symbol set.

After the nested-structure demapping, the user equipment successively performs demodulation, deinterleaving, rate dematching, and blind detection on the modulated symbol set; and the user equipment obtains, if the blind detection succeeds, the downlink control information corresponding to the user equipment, that is, obtains downlink control information sent by the network device for the user equipment. For a process of performing blind detection and decoding by the user equipment, refer to the schematic diagram of the receiving procedure shown in FIG. 2.

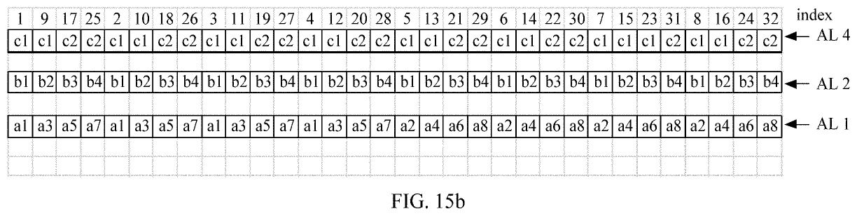

For the solution 1 in the embodiment described in FIG. 12, for an example diagram of candidate distribution obtained through the nested-structure demapping performed by the user equipment, refer to FIG. 15a. For blind detection at an AL 4 in FIG. 15a, an SNR of c1 is always close to an SNR of c2. For blind detection at an AL 2 in FIG. 15a, an SNR of b1 is always close to an SNR of b3 and an SNR of b2 is always close to an SNR of b4. For blind detection at an AL 1 in FIG. 15a, an SNR of a1 is always close to an SNR of a5, an SNR of a2 is always close to an SNR of a6, an SNR of a3 is always close to an SNR of a7, and an SNR of a4 is always close to an SNR of a8.

For the solution 2 in the embodiment described in FIG. 12, for an example diagram of candidate distribution obtained through the nested-structure demapping performed by the user equipment, refer to FIG. 15b. For blind detection at an AL 4 in FIG. 15b, an SNR of c1 is always close to an SNR of c2. For blind detection at an AL 2 in FIG. 15b, an SNR of b1 is always close to an SNR of b3 and an SNR of b2 is always close to an SNR of b4. For blind detection at an AL 1 in FIG. 15b, an SNR of a1 is always close to an SNR of a5, an SNR of a2 is always close to an SNR of a6, an SNR of a3 is always close to an SNR of a7, and an SNR of a4 is always close to an SNR of a8.

Regardless of how the network device maps the second resource block to an actual physical resource block in the embodiment described in FIG. 12, because SNRs of adjacent REs are close, a case in which SNRs of modulated symbols at adjacent candidate locations at a same aggregation level are close necessarily exists.

It may be understood that according to the embodiment described in FIG. 12, SNRs of LLRs that are input by the user equipment into a decoder and that are at different candidates at a same aggregation level are made close, and further the blind detection by the user equipment is benefited.

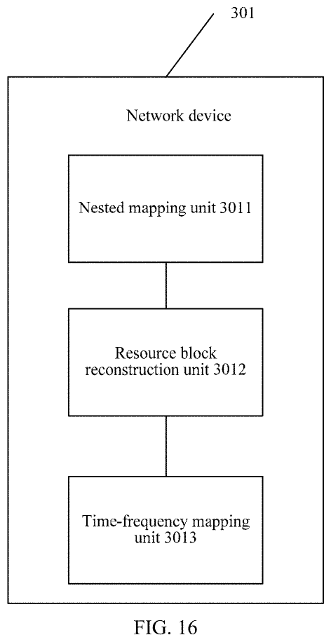

It should be noted that a resource mapping apparatus 301 shown in FIG. 16 may implement the embodiment shown in FIG. 12. A nested mapping unit 3011 is configured to perform step S101. A resource block reconstruction unit 3012 is configured to perform step S102. A time-frequency mapping unit 3013 is configured to perform step S103. The resource mapping apparatus 301 is, for example, a base station. The resource mapping apparatus 301 may alternatively be an application-specific integrated circuit (English: Application Specific Integrated Circuit, ASIC for short) or a digital signal processor (English: Digital Signal Processor, DSP for short) or a chip that implements a related function.

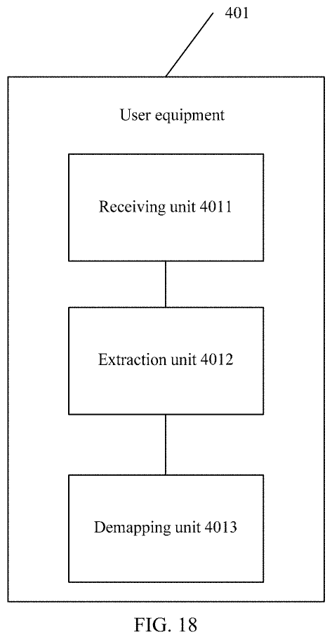

It should be noted that a resource demapping apparatus 401 shown in FIG. 18 can implement the embodiment shown in FIG. 14. A receiving unit 4011 is configured to perform step S201. An extraction unit 4012 is configured to perform step S202. A demapping unit 4013 is configured to perform steps S203 and S204. The resource demapping apparatus 401 is, for example, UE. The resource demapping apparatus 401 may alternatively be an ASIC or a DSP or a chip that implements a related function.

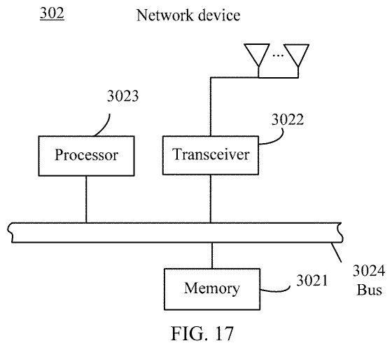

As shown in FIG. 17, this application further provides a network device 302. The network device may be a base station, or a DSP or an ASIC or a chip that implements a related resource mapping function. The network device 302 includes:

a memory 3021, configured to store a program, where the memory may be a random access memory (English: Random Access Memory, RAM for short) or a read-only memory (English: Read Only Memory, ROM for short) or a flash memory, and the memory may be separately located in a communications device, or may be located inside a processor 3023;

a transceiver 3022, which may be used as a separate chip, or may be a transceiver circuit inside the processor 3023 or be used as an input/output interface; and

the processor 3023, configured to execute the program stored in the memory, where when the program is executed, the processor 3023 performs nested-structure mapping on a modulated symbol set to obtain a first resource block, where the modulated symbol set carries downlink control information corresponding to each of at least one user equipment, and modulated symbols of same user equipment that are carried on the first resource block are consecutive; the processor 3023 reconstructs the first resource block to obtain a second resource block, where modulated symbols of same user equipment that are carried on the second resource block are non-consecutive; and the processor 3023 maps the second resource block to a time-frequency resource, so that the user equipment obtains the modulated symbol set based on the time-frequency resource.

The transceiver 3021, the memory 3022, and the processor 3023 are connected to each other by using a bus 3024.

It should be noted that the method performed by the processor 3023 is consistent with the content described in FIG. 12. Details are not described again.

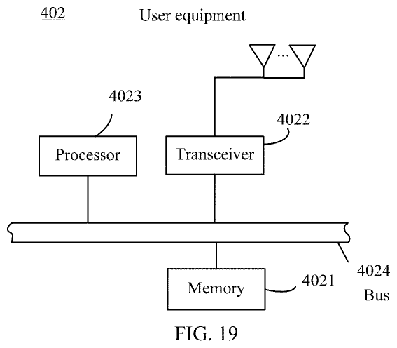

As shown in FIG. 19, this application further provides user equipment 402. The user equipment may be a base station, or a DSP or an ASIC or a chip that implements a related resource mapping function. The user equipment 402 includes:

a memory 4021, configured to store a program, where the memory may be an RAM or an ROM or a flash memory, and the memory may be separately located in a communications device, or may be located inside a processor 4023;

a transceiver 4022, configured to receive time-frequency resource indication information, where the transceiver 4022 may be used as a separate chip, or may be a transceiver circuit inside the processor 4023 or be used as an input/output interface; and

the processor 4023, configured to execute the program stored in the memory, where when the program is executed, the processor 4023 performs nested-structure mapping on a modulated symbol set to obtain a first resource block, where the modulated symbol set carries downlink control information corresponding to each of at least one user equipment, and modulated symbols of same user equipment that are carried on the first resource block are consecutive; the processor 4023 reconstructs the first resource block to obtain a second resource block, where modulated symbols of same user equipment that are carried on the second resource block are non-consecutive; and the processor 4023 maps the second resource block to a time-frequency resource, so that the user equipment obtains the modulated symbol set based on the time-frequency resource.

The transceiver 4021, the memory 4022, and the processor 4023 are connected to each other by using a bus 4024.

It should be noted that the method performed by the processor 4023 is consistent with the content described in FIG. 14. Details are not described again.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedures or functions according to the embodiments of this application are all or partially generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, a computer, a server, or a data center to another website, computer, server, or data center in a wired (for example, a coaxial cable, an optical fiber, or a digital subscriber line (English: Digital Subscriber Line, DSL for short)) or wireless (for example, infrared, radio, and microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD (English: Digital Video Disk, Chinese: digital video disc)), a semiconductor medium (for example, a solid state disk (English: Solid State Disk, SSD for short)), or the like.

1. A resource mapping method, comprising:
performing nested-structure mapping on a modulated symbol set to obtain a first resource block, wherein the modulated symbol set carries downlink control information corresponding to each of at least one user equipment, and modulated symbols of same user equipment that are carried on the first resource block are consecutive;
reconstructing the first resource block to obtain a second resource block, wherein modulated symbols of same user equipment that are carried on the second resource block are non-consecutive; and
mapping the second resource block to a time-frequency resource.

2. The method according to claim 1, wherein the reconstructing, by the network device, of the first resource block to obtain a second resource block comprises:
performing one time of row-column interleaving on the first resource block to obtain the second resource block, wherein a column width of the one time of row-column interleaving is 2n, and n is a positive integer.

3. The method according to claim 1, wherein the reconstructing of the first resource block to obtain a second resource block comprises:
performing at least two times of row-column interleaving on the first resource block to obtain the second resource block, wherein a column width of each of the at least two times of row-column interleaving is 2n, n is a positive integer.

4. The method according to claim 1, wherein the method further comprises:
Successively performing channel encoding, rate matching, interleaving, and modulation on the downlink control information and cyclic redundancy code check information that correspond to each user equipment, to obtain the modulated symbol set, wherein the modulated symbol set comprises modulated symbols corresponding to the user equipment.

5. A resource demapping method, comprising:
receiving time-frequency resource indication information, and obtaining a time-frequency resource according to the time-frequency resource indication information;
performing time-frequency resource demapping on the time-frequency resource to obtain a nested-structure resource block; and
performing nested-structure demapping on the nested-structure resource block to obtain a modulated symbol set, wherein the modulated symbol set carries downlink control information corresponding to each of at least one user equipment.

6. The method according to claim 5, wherein the method further comprises:
successively performing demodulation, deinterleaving, rate dematching, and blind detection on the modulated symbol set; and
obtaining if the blind detection succeeds, the downlink control information corresponding to the user equipment.

7. A network device, comprising:
a memory, configured to store a program; and
a processor, configured to execute the program stored in the memory, wherein when the program is executed, the processor performs nested-structure mapping on a modulated symbol set to obtain a first resource block, wherein the modulated symbol set carries downlink control information corresponding to each of at least one user equipment, and modulated symbols of same user equipment that are carried on the first resource block are consecutive; the processor reconstructs the first resource block to obtain a second resource block, wherein modulated symbols of same user equipment that are carried on the second resource block are non-consecutive; and the processor maps the second resource block to a time-frequency resource.

8. The apparatus according to claim 7, wherein the processor is configured to perform one time of row-column interleaving processing on the first resource block to obtain the second resource block, wherein a column width of the one time of row-column interleaving is 2n, and n is a positive integer.

9. The apparatus according to claim 8, wherein the processor is configured to perform at least two times of row-column interleaving processing on the first resource block to obtain the second resource block, wherein a column width of each of the at least two times of row-column interleaving is 2n, n is a positive integer.

10. The apparatus according to claim 7, wherein the processor is further configured to: successively perform channel encoding, rate matching, interleaving, and modulation on the downlink control information and cyclic redundancy code check information that correspond to each user equipment, to obtain the modulated symbol set, wherein the modulated symbol set comprises modulated symbols corresponding to the user equipment.

11. User equipment, comprising:
a memory, configured to store a program;
a transceiver, configured to receive time-frequency resource indication information; and
a processor, configured to execute the program stored in the memory, wherein when the program is executed, the processor obtains a time-frequency resource according to the time-frequency resource indication information; the processor performs time-frequency resource demapping on the time-frequency resource to obtain a nested-structure resource block; and the processor performs nested-structure demapping on the nested-structure resource block to obtain a modulated symbol set, wherein the modulated symbol set carries downlink control information corresponding to each of at least one user equipment.

12. The apparatus according to claim 11, wherein the processor further configured to:
successively perform demodulation, deinterleaving, rate dematching, and blind detection on the modulated symbol set; and obtain, if the blind detection succeeds, the downlink control information corresponding to each of at least one of user equipment.

13. (canceled)

14. (canceled)
